(19) United States
(12) Patent Application Publication
(10) Pub. No.: US 2015/0058166 A1
(43) Pub. Date: Feb. 26, 2015

(54) Computer controlled commercial transactional

(71) Applicants: Gene Dion, Longueuil (CA); Rosa Margarita Rosario-Jaquez, Longueuil (CA); Jocelyn Juneau, Montreal (CA); Normand Brault, Boucherville (CA)

(72) Inventors: Gene Dion, Longueuil (CA); Rosa Margarita Rosario-Jaquez, Longueuil (CA); Jocelyn Juneau, Montreal (CA); Normand Brault, Boucherville (CA)

(73) Assignee: Osmora Technologies Inc.

(21) Appl. No.: 13/987,691

(22) Filed: Aug. 22, 2013

(51) Int. Cl. G06Q 30/06

(52) U.S. Cl. CPC G06Q 30/0613
USPC 705/26.41

(57) ABSTRACT

An independently operated computer-controlled transactional method and system for facilitating sales, rentals, promotion, streaming content, bartering and exchange of digital and/or physical products and/or services between a property owner and one or more web stores is described. It embodies business methods that are necessary to conduct commerce on a local, regional and international level over the Internet or computer networks that are interconnected through communication links, by packaging, warehousing and delivering digital and/or physical products and/or services of an owner of such products and/or services and parties distributing to end users.

### TECHNICAL FIELD

The present invention relates to commercial transactional methods and systems and particularly to a facilitating computer-controlled commercial transactional method and system for communication and data processing of property of a property owner to web stores for the sale thereof and wherein the method and system is independently operated.

### BACKGROUND OF THE INVENTION

Websites that sell digital content or services and physical products through the Internet are known. These websites post content for end-users to purchase products and/or download digital content. With the advent of large web stores offering a wide variety of digital and/or physical products and services all under one banner or website, a window of opportunity is now opened for owner of products, digital content and/or services to extend and add new sales channels to promote and distribute their products and services. These large web stores reach a worldwide audience, attracting a large customer base and drive customers to buy products and services from their own web portal. As an example and to name but a few, the App Store at Apple, Amazon, Google Android Market and eBay offer multiple digital and/or physical products for sale by third party owner of products, digital content and/or services. By selling or promoting outside their own websites, an owner of products, digital content and/or services will reach far more customers and generate more sales through acclaimed and recognized distribution channels than marketing and selling solely by means of their own websites. Consequently, a new breed of sales channels have appeared on the Internet achieving considerable visibility for purchasing, renting, promoting and exchanging products and services worldwide. As a result, large web stores must deal with an abundance of different digital files, products and promotional material originating from a wide variety of owner of products, digital content and/or services which in most cases, are not compatible with their own proprietary software, device compatible digital formats, website packaging/uploading specifications and warehousing requirements. Although web stores post specs, technical guidelines, tax forms and requirements on their own website, conditions differ from one web store to another, making this a complex undertaking when dealing with more than one web store. Distributing through multiple web stores by product owners requires technical, legal, commercial, international sales/income tax and management expertise. Given the diversity of web stores and distribution channels available today, costs, commission charges, foreign exchange rates and consolidating and tracking of sales reports from incoming web store then become an even greater challenge. Web stores need specific digital formats and files, apply unique methods and software tools to upload data and fill out compulsory and regulatory tax forms. Consequently, owners of products, digital content and/or services will go through extensive trial and error stages before they can even begin to promote their products with web stores or get rejected from accessing such distribution channels for lack of competence. Digital files are declined and dismissed, agreements are unclear and irrelevant, taxation is incorrect or inapplicable, digital products are defective or inoperable, sales reports are complex to decipher according to recognized accounting rules and file ordering/delivery instructions become unserviceable.

### SUMMARY OF THE INVENTION

It is a feature of the present invention to provide a facilitating computer-controlled transactional business method and system for packaging, warehousing, delivering, tracking, managing and payment/auditing mechanism for property between an owner of the property including physical products, digital content and/or services and web stores selling, renting, streaming, promoting and bartering of the property to end users. End users cannot purchase, exchange or download digital content directly from the owner of the property unless the owner is also one of the web stores. The transactional method and system re-directs purchases through hyperlinks to web stores. The web stores are the preferred distributors who deals and sells directly to end users.

In the present invention, digital content is delivered through a bi-directional content delivery platform using Point to Multi-Point (P2MP), Multi-Point to Point (MP2P) and Point to Point (P2P). Billing, monitoring, consolidated reports, management, tracking of digital content and products are done using algorithms and Application Programming Interface (API's) for communication between servers. Management module for sales tax and tax withholding compliance for local, regional, federal and international jurisdictions and audited sales validation also require to be processed through a certified and accredited mechanism. Service charges and automated sales reports are processed through secured payment gateways or other legal and secured payment mechanisms. According to a broad aspect of the present invention there is provided a method of facilitating commercial transactions through the web for the sale of property of a property owner with one or more web stores. The method comprises operating by an independent entity a computer-controlled transactional system for communication and data processing of the property of the property owner to the one or, more web stores, The system has a computer with a programmable memory for storing statements and instructions for use in the execution of the communication and data processing. The method also comprises formatting in a delivery module of the transactional system a URL web page of the property owner's information including the property. The formatted URL web page is ported on a public web site of the transactional system. The formatted property is delivered, through secured server engines, in a form for posting on the web stores for distribution and access by end users. Data received from the web stores relating to transactions of the property with end users is managed in a management module wherein the received data is consolidated in formatted standard reports for access by the property owner or authorized representatives or legal entities, such as the government. Secured access to the management module is provided to the property owner for access to the formatted standard reports and the data downloaded from the one or more web stores and relating to sale of the property of the property owner.

According to another broad aspect of the present invention there is provided a facilitating independently computer-controlled commercial transactional system for communication and data processing of property of a property owner to one or more web stores and wherein the transactional system is operated by an independent entity. The system comprises a computer having a programmable memory for storing statements and instructions for use in the execution of the communication and data processing. A delivery module delivers the property in a format for display by the web stores for access by end users through the web. The delivery module has a URL page for access by end users through the web stores. A management module receives data from the web stores relating to transactions of the property by end users and consolidates the data into formatted standard reports. The management module is formatted to consolidate and store data in the memory relating to the transactions of each said web stores. The property owner has a secured access code for access to the management module where the formatted standard reports and the transaction data relating to sale of his property is stored. Secured information in the delivery module is inaccessible to both the property owner and the web stores.

### BRIEF DESCRIPTION OF THE DRAWINGS

A preferred embodiment of the present invention will now be described with reference to the accompanying drawings in which:

FIGS. 1A and 1B are schematic illustrations of present business practices versus the business method of the present invention;

FIG. 2 is a block diagram illustrating an embodiment of the present invention;

FIG. 3 is a block diagram of the legal and contractual process that enables recognition of business practices such as intellectual property and world wide tax compliance according to International tax treaties;

FIG. 4 is a flow diagram of a routine that processes packaging and warehousing of digital content for distributing to end users;

FIG. 5 is a flow diagram illustrating delivery and promotion of digital products and services;

FIG. 6 is a flow diagram illustrating delivery of physical products and services to third parties or end users;

FIG. 7 is a flow diagram of a routine generating a promotional webpage re-directing online purchases to multiple retail stores, web portals and third parties;

FIG. 8 is a block diagram illustrating a routine that enables receiving sales reports and proceeds;

FIG. 9 is a flow diagram of an implementation of a management module algorithm;

FIG. 10 is a flow diagram illustrating sales tracking, payment mechanism and sales proceeds validation from the entity owner of the transactional system to the property owner; and

FIG. 11 is a flow diagram illustrating sales tracking of web stores sales.

### DETAILED DESCRIPTION OF THE INVENTION

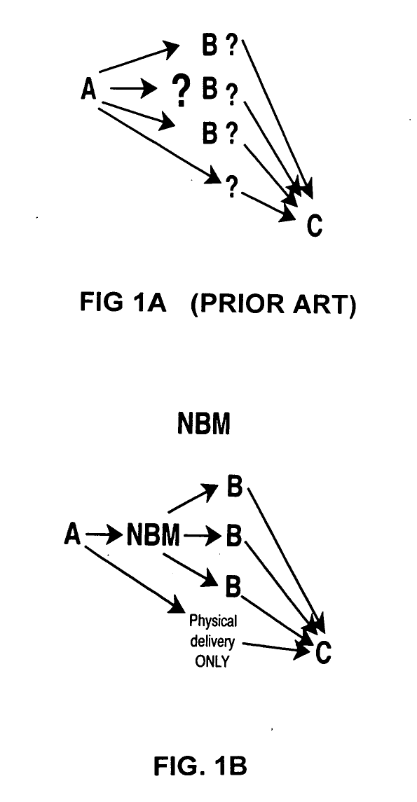

FIGS. 1A and 1B are illustrations of the present business practice 10 versus the new business method of the present invention for the purpose of depicting a generic understanding of the need for such an invention in the market place. In the present description and to avoid repeating certain terms A designates and encompasses an owner of digital or physical property, his physical warehouse and/or a digital gateway distributing to B, a distributor, and/or selling or delivering physical products directly to C, an end user, buyer, purchaser consumer of digital and/or physical products and services. The distributor B designates and encompasses online retail store(s), repositories, web distribution outlet(s), retail stores, e-distributors, libraries or websites, web portals and any party distributing, selling, renting, streaming and/or promoting physical or digital products, all of which is herein also referred to as “web stores”.

NBM designates the commercial transactional method and system of the present invention. NBM occupies all business space between A and B for the purpose of facilitating commerce between the parties. NBM manages packaging, warehousing and delivery of digital information between the parties including worldwide tax compliance, consolidated sales reports and tracking system, legal, auditing and validation of sales on behalf of the parties involved. A and B are fully compliant.

The question mark “?” represents trial and error method, incompatible packaging and delivery standards rejected by most B and C, local, regional and/or international tax issues (possibly illegal), fragmented tracking of sales (possible loss of income), auditing and sales validation is very difficult, close to impossible. A and B are therefore at risk.

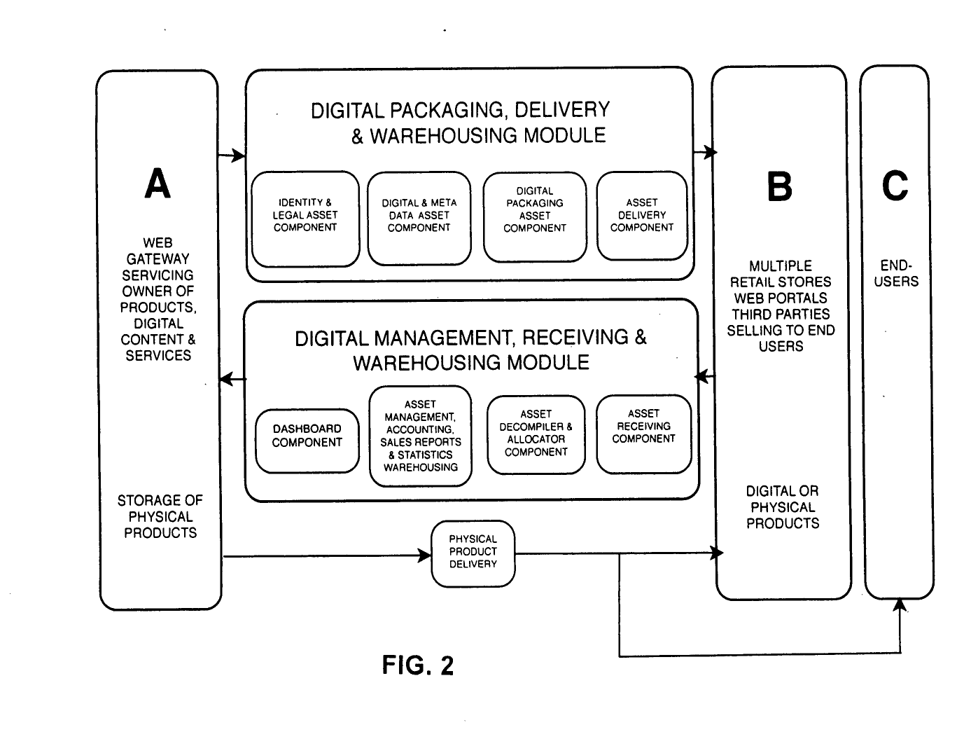

Referring now to FIG. 2 it illustrates an embodiment of the present invention 11 depicting the whole business method and system 12 of the present invention for packaging, warehousing, delivering, tracking, managing and payment/auditing mechanism for products and services between an owner 13 of physical products, digital content/services and parties B 14 distributing to end users C 15. In a delivery module 16 there is illustrated the steps of digital packaging 17, delivery 18 and warehousing of identity and legal documents 19, meta data files, digital files 20 are processed and delivered to distributor B 14. Physical product delivery is performed from A 13 to B 14 or from property owner A 13 directly to end user C 15. Once C has purchased or downloaded content from the distributor B, B sends sales reports, statistics to a receiving module 21 of the transactional system NBM who then enables secured access of all sales, rental, streaming, promotional or exchange activity details to the property owner A, or an authorized representative thereof, or a legal authority, through a web gateway dashboard 22 or application program. Payment is disbursed according to conventions and agreements between the parties and paid through legal and recognized payment mechanisms. In essence the transactional system NBM encompasses all business space between A and B for the purpose of facilitating commercial transactions between the parties. Blocks 23, 23′, and 23″ illustrate some of the treatment of the received statistics and payments from the web stores distributors 14.

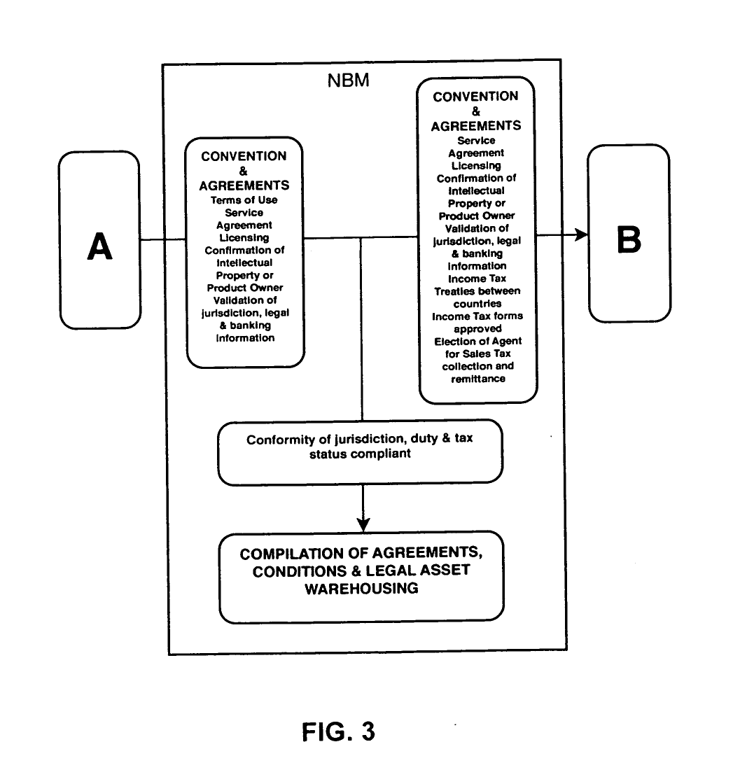

Referring to FIG. 3 there is illustrated in block diagram form the legal and contractual process that enables recognition of business practices such as, but not limited to, intellectual property implementing worldwide tax compliance according to International tax treaties depicting the complete process by which worldwide taxation issues are managed. Individual and separate conventions between A and B are managed by the transactional system. NBM establishes compatible guiding rules between the parties. Accordingly, property owner A signs all terms of use, service agreements, licensing, banking information, and validates and authenticates any intellectual property and product owner and/or distribution rights, trade marks, licensing rights and validates taxation jurisdiction, see block 24′. This will then enable the property owner A to sell worldwide using channels of the distributors B. The owner of the transactional system NBM will sign with the distributors B on behalf of A, see block 24″, distribution agreements, licensing, confirmation/grant of intellectual property ownership, product/distribution rights. Since NBM acts as the middle man with limited powers of attorney, NBM must validate tax jurisdiction, see block 24′″, NBM, elect distributor B as a sales tax agent or remit sales taxes directly to the appropriate government authorities, apply tax treaties, collect withholding tax on behalf of governments, validate banking information for sales proceeds. Once the property owner A, the owner of the NBM and the distributor B have completed, signed and complied with all conditions, terms, legal agreements and tax documents, digital files are warehoused on the transactional system NBM's server engines 24.

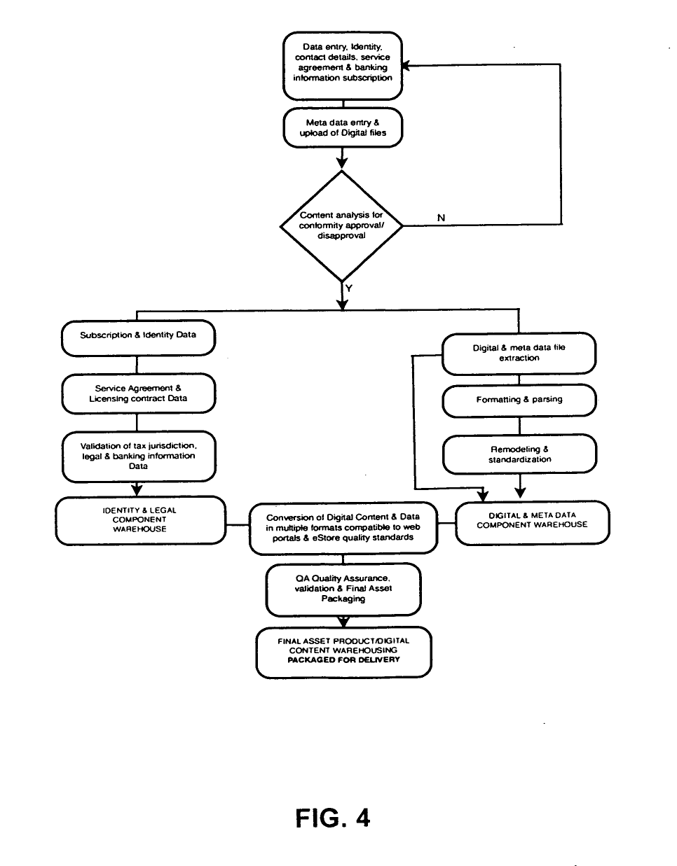

FIG. 4 is a flow diagram 25 illustrating, in block form, information processing in the delivery module 16 a routine that processes packaging and warehousing of digital products and services for distributing to end users. Property owner A accesses secured web gateway of NBM and enters general information, contact details, service agreement and banking information directly from the web and sends subscription form to open an account. Subscription filtering and email identity validation (real or bogus subscriptions filtered). Customer accesses secured Dashboard web Portal or application program (PIN and Username) to manage Workflow status of digital files and choice of upload options which is then processed for content analysis for conformity approval or disapproval.

Subscription and identity data, terms of use, service agreement, licensing contract, confirmation of intellectual property ownership and grants, validation of jurisdiction, legal and banking information is then warehoused on NBM's secured server engines.

Digital and meta data file extraction, formatting and parsing, remodeling and standardization is then warehoused on NBM's secured server engines. Conversion of digital content and data is processed in multiple formats compatible with third party web portals and web stores quality standards. Quality Assurance validation and final asset packaging for delivery is then warehoused on NBM's secured server engines 18.

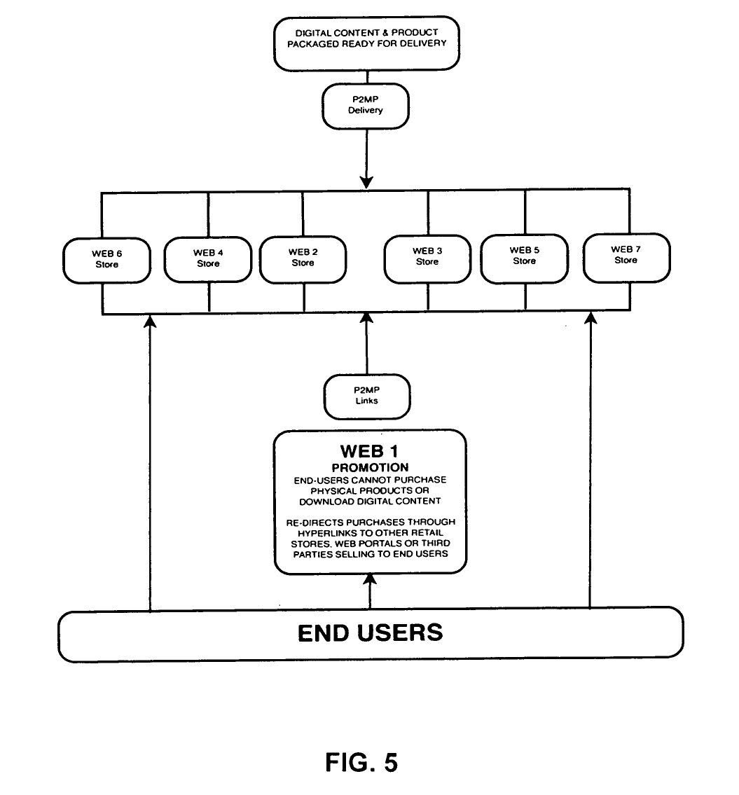

FIG. 5 is a flow diagram 26 illustrating in block form delivery and promotion of digital products and services 18 from NBM's secured server engines to B. Automatic Point to Multi-Point (P2MP) delivery 27 to B for distribution. NBM's algorithm will then track posting of digital content on multiple web stores and as soon as content is officially online with B or any individual web store, NBM's algorithm will automatically generate a promotional webpage 28 of A's property with all pertinent information on NBM's public website 28, destined to advertise A's products or services. Given A now has a dedicated URL page on NBM's public website, Google Ad-Words or similar forms of promotional tools can now be tagged to A's property to generate web traffic and promotion. NBM's public website 28 will then re-direct 29 incoming C's to all web stores B. C's can now go to NBM's public website, choose the product or service they intend to purchase, click on one of the B banners or hyperlinks and get re-directed to the web store they prefer to purchase A's products or services. Additionally, all digital information has been sent to B for distribution, consequently C's can also access A's products or services through B's marketing channels and promotional efforts.

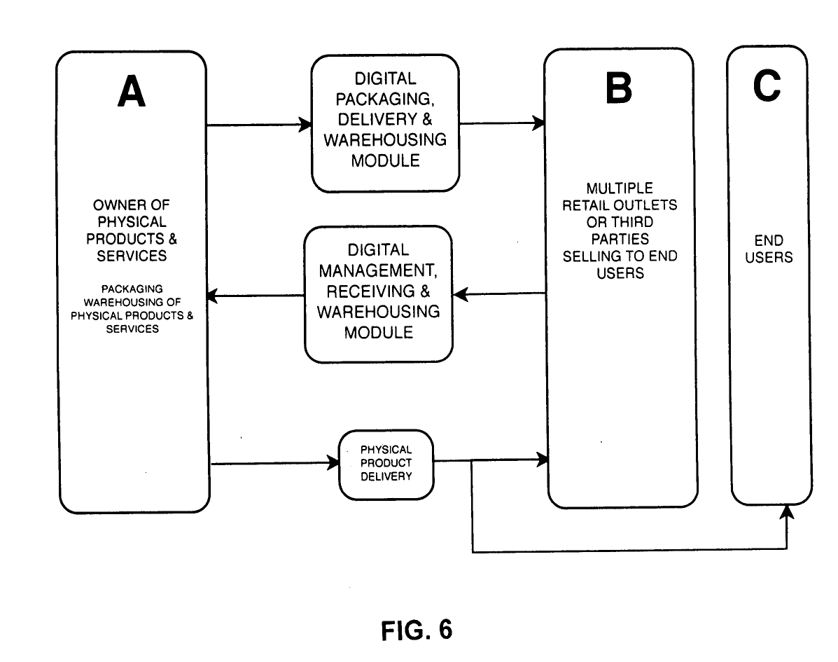

FIG. 6 is a flow diagram 30 illustrating, in block form, delivery of owner's physical products and services 13 to third parties or end users 15. The digital packaging, delivery and warehousing module 16 and a digital management, receiving, and warehousing module 21 are used as a complete packaging, identification and tracking mechanism for delivery of physical products to B or C. In this diagram, property owner A 13 delivers physical products directly to web store B 14 or end user C 15, see block 31, according to action ordering by end user C.

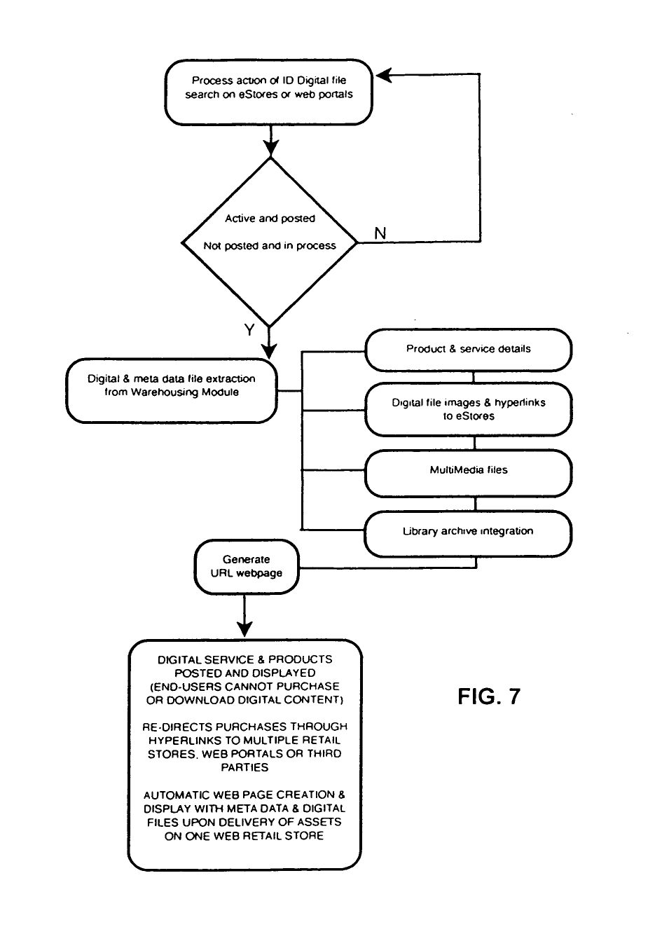

FIG. 7 is a flow diagram 32 of a routine generating a promotional item webpage re-directing online purchases to web store B or multiple web stores. NBM's algorithm processes action of ID digital file search on web stores B. If a web store B hasn't posted promotional item of A on website of B for official distribution, the action (not posted and in process) will prompt NBM's algorithm to trigger a series of sequential actions until B has posted A's products or services. Once B has posted A's products or services on B's website and marketing channels, it will trigger NBM's algorithm to extract details, digital file images, hyperlinks, multimedia files of property owner A's products and services, see block 34, from NBM's digital warehousing module 16 and automatically generate a URL webpage 35 of A's products or services on NBM's public website while archiving all digital content related to A's products or services. End users cannot purchase or download digital content directly from NBM's public website as it only re-directs C's through hyperlinks to B for final purchase or consumption of A's products or services.

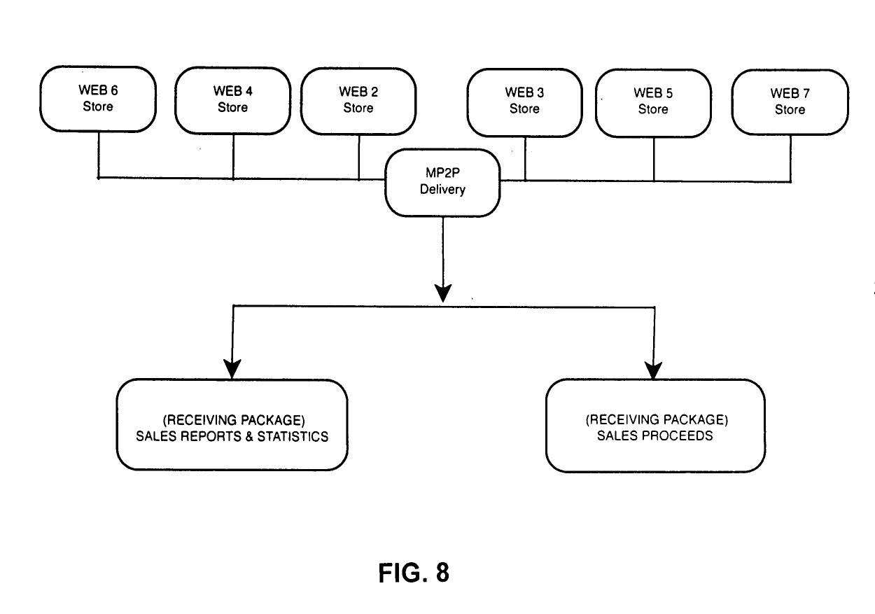

FIG. 8 is a flow diagram 36 of a routine that enables receiving sales reports and proceeds by the receiving module 21. When individual constituents of B (web store per web store) completes a sales cycle, sales reports are sent Multi-Point to Point (MP2P) 37 to the receiving module 21 of NBM by electronic means. Financial proceeds are paid to NBM and treated as illustrated by block 38. The payments may be by wire transfer, credit card, debit, check and/or any other form of legal exchange to NBM's multi-currency segregated bank account and/or other payment mechanism. Other statistics are treated separately, as shown by block 39, for access and display on the dashboard component 22, see FIG. 2.

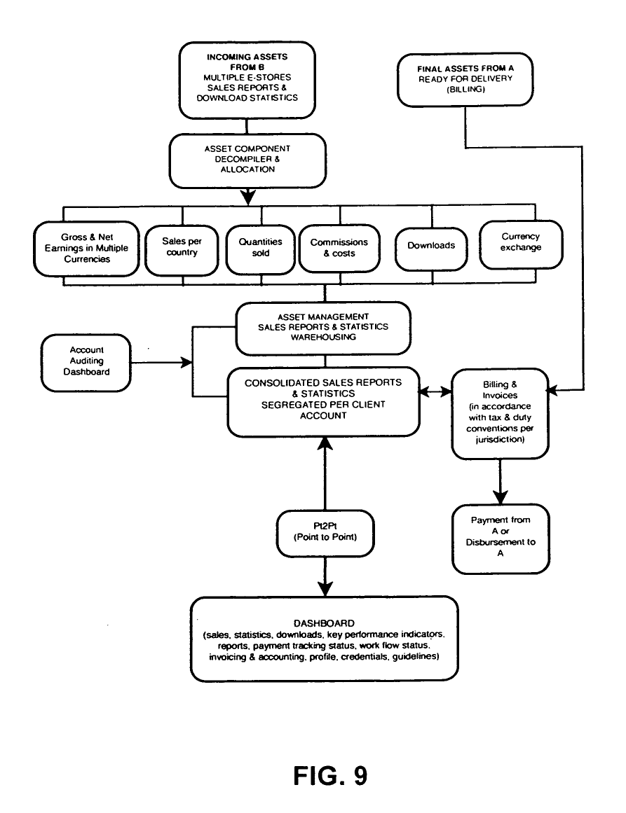

FIG. 9 is a flow diagram 40 of a routine that implements the algorithm of the management module 21 to effect the complete management of incoming (assets) sales reports, statistics, billing, payments and online tracking of products and services sold, rented, streamed, promoted, bartered or exchanged. In certain cases, NBM may invoice and process payment of A for preparation of Digital files once A has uploaded all digital files on NBM's dashboard servers. Invoicing is based on tax and duty conventions and jurisdictions where A has established their business or headquarters. The blocks in this flow diagram describe the various treatments of the assets and statistics received from the web stores 14.

As illustrated, once B has sent sales reports and statistics to NBM, NBM's algorithm will then decompile incoming assets/reports and divide them into gross/net earnings in multiple currencies (see block 41), sales per country (block 42), quantities sold (block 43), commissions and costs (block 44), downloads (block 45) and currency exchange rates and transaction costs (block 46) by web store B. Upon completion, sales reports and statistics will be warehoused, see block 47, on NBM's servers and segregated for each and every A. Property owner A can then access via Point to Point communication the secured dashboard 22 web portal or application program detailing sales, statistics, downloads, key performance indicators, reports, payment tracking status, work flow status, invoicing, accounting, profile, credentials and guideline information to track and dissect sales/downloads of digital and/or physical products and services per country and item. Accounting validation of sales through an identification system will enable individual and/or collective auditing mechanism for each and every A. Based on sales reports and reception of payment from B of A's digital and/or physical products and services, disbursement to A will be processed accordingly.

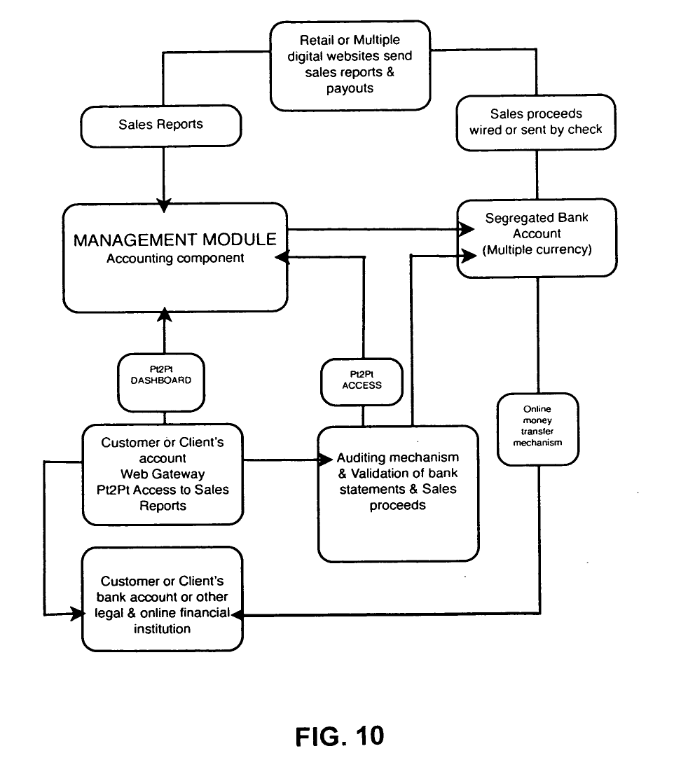

FIG. 10 is a flow diagram 49 illustrating sales tracking, payment mechanism and sales proceeds validation (from B to A). Sales reports 50 are sent from B to NBM by electronic means while sale (monetary or value of exchange of goods and services) proceeds 51 are wired, exchanged or sent by check to NBM's segregated and multi-currency bank account or other form of value exchange mechanism. Based on sales proceeds owed to A, NBM shall pay A by check or online money transfer or exchange of value mechanism 53. A can then access the point to point secured dashboard web portal or application program detailing sales reports, payment tracking status, invoicing and accounting information, see block 54, to track and dissect sales/downloads of digital and/or physical products and services per country and item. Jointly, an auditing and validation mechanism 55 based on deposits to NBM's segregated and multi-currency bank account or other form of value exchange mechanism from B of A's digital and/or physical products and services sold or exchanged, enables A to substantiate sales proceeds worldwide and displays total and absolute transparency of NBM's authenticity.

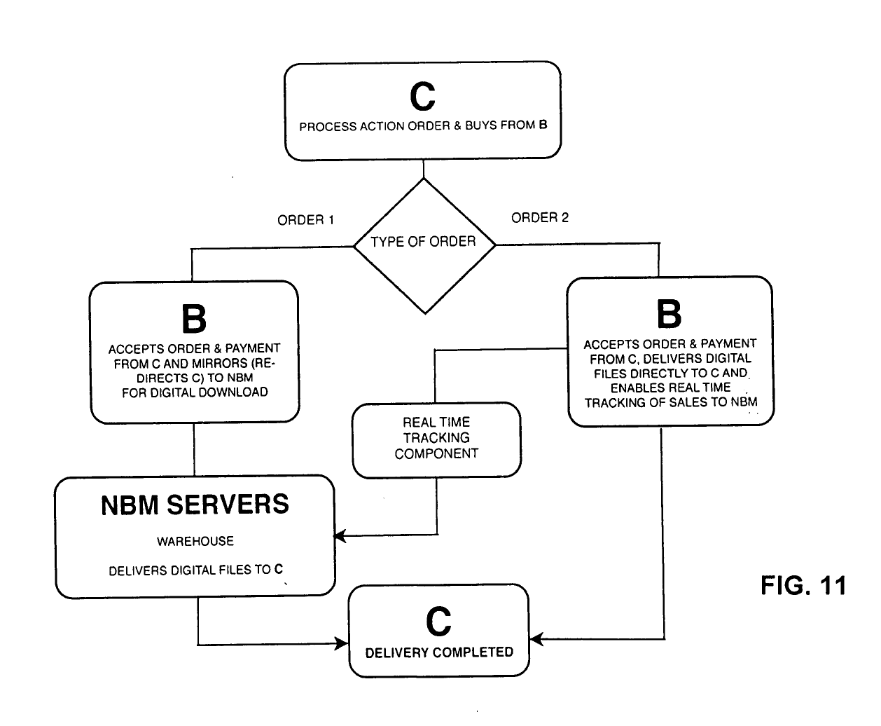

FIG. 11 is a flow diagram 56 for sales tracking the sale of the property of a property owner. The diagram illustrates a scenario (order 2) where the web store 14 delivers the property directly to the consumer end user 15, see link line 57, and enables real time tracking 58 of the transaction by NMB 12. In a further scenario (order 1) the sale is made through the servers of NMB 12 which delivers the property to the end user 15.

It is within the ambit of the present invention to cover all modification of the embodiment disclosed herein provided such modifications fall within the scope of the appended claims.

1. A method of facilitating commercial transactions through the web for the sale of property of a property owner with one or more web stores owners, said method comprising the steps of:
(i) operating by an independent entity a computer-controlled transactional system for communication and data processing of said property of said property owner to said one or more web stores, said system having a computer with a programmable memory for storing statements and instructions for use in the execution of said communication and data processing,
(ii) formatting in a delivery module of said transactional system a URL web page of said property owner including said property,
(iii) posting said formatted URL web page on a public web site of said transactional system,
(iv) delivering through secured server engines said formatted property in a form for posting on said web stores for distribution and access by end users,
(v) managing in a management module data received from said web stores relating to transactions of said property with said end users and consolidating said data in standard formatted reports for access by said property owners or authorized representatives thereof, and
(vi) providing secured access to said management module to said property owner for access to said standard formatted reports and the data downloaded from said one or more web stores and relating to sale of said property of said property owner.

2. A method as claimed in claim 1 wherein there is further provided before step (ii) the step of establishing a communication link between said property owner and said web stores through the execution of a service agreement by both said property owner and said web stores establishing compatible guide rules.

3. A method as claimed in claim 1 wherein said step (ii) comprises the step of digital packaging and warehousing of documents and meta data files and digital files of said property owner.

4. A method as claimed in claim 3 wherein said property is one of digital information property and physical information property or services, and wherein there is further provided the step of delivering said physical property from said property owner through web stores or directly to said end users, said digital information property being downloaded to said end users through said web stores.

5. A method as claimed in claim 1 wherein said step (v) comprises managing through said management module sales reports and statistics received from said web stores, and executing payment to said property owner through legal and recognized payment mechanisms.

6. A method as claimed in claim 5 wherein said step (iv) further comprises providing through a secured web gateway of said retail web stores information details of the property and identity of said property owner including, but not limited to, banking information to open an account for end user access through a secured dashboard web portal for purchase of said property and warehoused on said web stores in secured server engines.

7. A method as claimed in claim 5 wherein said step of managing sales reports and statistics further comprise automatically decompiling said sales reports and statistics to divide them in gross/net earnings in multiple currencies, and exchanges, providing statistics per countries, sales per quantity, commissions and costs by downloads from said web stores and transaction costs and taxes and commissions to said independent entity owner of said transactional system.

8. A method as claimed in claim 1 wherein said step (iv) comprises automatically delivering said property through secured server engines through point to multi-point (P2MP) delivery and using algorithms and application programming interface (API's), and tracking by said independent entity said posting of said property on said web stores to track purchases of said property through said web stores.

9. A method as claimed in claim 1 wherein there is further provided the step of providing an independent access connection to said management module of said transactional system by an independent auditing and validation entity to verify sales reposts and statistics received from said web stores and all treatments thereof in said management module.

10. A method as claimed in claim 1 wherein there is further provided the step of delivering orders from said end users by said web stores directly to said end users via servers of said transactional system or directly to said end users with a tracing connection to said transactional system.

11. A method as claimed in claim 1 wherein there is further provided the step of redirecting to said web stores end user access to said property on said public web site of said transactional system for said end user to choose from which web stores it wishes to purchase said property.

12. A method as claimed in claim 1 wherein said step (ii) further comprises the step of providing to said property owner access, by a secured web gateway, to said transactional system for said property owner to upload information required to open an account and to provide information for formatting said URL webpage, said information being warehoused in secured server engines of said delivery module.

13. A facilitating computer-controlled commercial transactional system for communication and data processing of property of a property owner to one or more web stores and wherein said transactional system is operated by an independent entity, said system comprising a computer having a programmable memory for storing statements and instructions for use in the execution of said communication and data processing, a delivery module for delivery of said property in a format for display by said web stores for access by end users through the web, said delivery module having a URL page for access by said end users through said web stores, said URL page being posted on a public web site of said transactional system for access by end users, a management module for receiving data from said web stores relating to transactions of said owner of said property by said end users, said management module being formatted to consolidate and store data in said memory relating to said transactions of each said web stores and provide standard formatted reports for access by said property owner, and secured access means to provide access to said management module of said standard formatted reports and the transactions by said property owner, and secured information in said delivery module being inaccessible to both said property owner and said web stores.

14. The facilitating independently computer-controlled transactional system as claimed in claim 13 wherein said management module is a digital management receiving and warehousing module programmed to treat and store assets and statistical components relating to said transactions of said owner property, and a dashboard component to provide access by said property owner to said assets and statistical components stored in said management module.

15. The facilitating independently computer-controlled transactional system as claimed in claim 14 wherein said delivery module is a digital packaging, delivery and warehousing module programmed to store personal property of a property owner, and deliver said formatted property of said property owner to said one or more web stores through secured servers of said independent entity owner of said commercial transactional system.

16. The facilitating independently computer-controlled transactional system as claimed in claim 15 wherein said formatted property is one of digital information property, physical property and services property.

17. The facilitating independently computer-controlled transactional system as claimed in claim 14 wherein said formatted property is converted and packaged in multiple formats compatible for delivery via said secured servers to said web stores.

18. The facilitating independently computer-controlled transactional system as claimed in claim 14 wherein said personal property of said property owner comprises subscription and identity data, service agreements, banking and tax information and any confidential information required for transacting with said web stores and with said owner of said transactional system.

19. The facilitating independently computer-controlled transactional system as claimed in claim 14 wherein said assets and statistics downloaded from a web store are decompiled and allocated for storage in said memory of said computer and available to said property owner through said dashboard by a secured access code, said assets being segregated to calculate and issue a payment to said property owner taking into account tax issues and commission payments

20. The facilitating independently computer-controlled transactional system as claimed in claim 19 wherein said management module further comprises an independent access connection to said management module for auditing and validation of the processing of said assets and statistics of any property owner by an independent audit authority.

21. The facilitating independently computer-controlled transactional system as claimed in claim 13 wherein said URL page posted on said public web site has a link to said web stores for redirecting end user access to said property to said web stores whereby said end users can select which web store it wishes to transact with to buy said property.
